(19) United States
(12) Patent Application Publication
(10) Pub. No.: US 2006/0154169 A1
(43) Pub. Date: Jul. 13, 2006

(54) Radiation-sensitive compositions comprising a 1,4-dihydropyridine sensitizer and imageable elements based thereon

(76) Inventor: Hans-Joachim Timpe, Osterode/Harz (DE)

Correspondence Address: PATENT LEGAL STAFF, EASTMAN KODAK COMPANY, 343 STATE STREET, ROCHESTER, NY, 14650-2201, US

(21) Appl. No.: 10/559,231

(22) PCT Filed: Jun. 8, 2004
(86) PCT No.: PCT/EP04/06185

§ 371 Date: Dec. 6, 2005

(30) Foreign Application Priority Data
Jun. 11, 2003 (EP) 103 26 324.1

(51) Int. Cl. G03C 5/18

(52) U.S. Cl. 430/141

(57) ABSTRACT

Radiation-sensitive composition comprising: (a) one or more types of monomers and/or oligomers and/or polymers, each comprising at least one ethylenically unsaturated group accessible to a free-radical polymerization, (b) at least one sensitizer, (c) at least one coinitiator capable of forming free radicals together with the sensitizer (b) and selected from hexaarylbiimidazoles; and (d) optionally one or more components selected from alkali-soluble binders, dyes, exposure indicators, plasticizers, chain transfer agents, leuco dyes, surfactants, inorganic fillers and thermopolymerization inhibitors,
characterized in that the at least one sensitizer is a 1,4-dihydropyridine derivative of the formula (I) 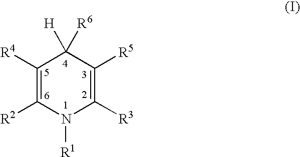 which does not contain any nitro groups bonded to an aromatic ring.

The present invention relates to radiation-sensitive compositions, in particular radiation-sensitive compositions comprising 1,4-dihydropyridine derivatives as sensitizers. The invention furthermore relates to negative working imageable elements based thereon, a process for producing such elements, a process for imaging such elements, as well as to an imaged element such as e.g. a lithographic printing form.

The technical field of lithographic printing is based on the immiscibility of oil and water, wherein the oily material or the printing ink is preferably accepted by the image area, and the water or fountain solution is preferably accepted by the non-image area. When an appropriately produced surface is moistened with water and a printing ink is applied, the background or non-image area accepts the water and repels the printing ink, while the image area accepts the printing ink and repels the water. The printing ink in the image area is then transferred to the surface of a material such as paper, fabric and the like, on which the image is to be formed. Generally, however, the printing ink is first transferred to an intermediate material, referred to as blanket, which then in turn transfers the printing ink onto the surface of the material on which the image is to be formed; this technique is referred to as offset lithography.

A frequently used type of lithographic printing plate precursor comprises a photosensitive coating applied onto a substrate on aluminum basis. The coating can react to radiation such that the exposed portion becomes so soluble that it is removed during the developing process. Such a plate is referred to as positive working. On the other hand, a plate is referred to as negative working if the exposed portion of the coating is hardened by the radiation. In both cases, the remaining image area accepts printing ink, i.e. is oleophilic, and the non-image area (background) accepts water, i.e. is hydrophilic. The differentiation between image and non-image areas takes place during exposure, for which a film is attached to the printing plate precursor under vacuum in order to guarantee good contact. The plate is then exposed by means of a radiation source. Alternatively, the plate can also be exposed digitally without a film, e.g. with a UV laser. When a positive plate is used, the area on the film corresponding to the image on the plate is so opaque that the light does not reach the plate, while the area on the film corresponding to the non-image area is clear and allows light to permeate the coating, whose solubility increases. In the case of a negative plate, the opposite takes place: The area on the film corresponding to the image on the plate is clear, while the non-image area is opaque. The coating beneath the clear film area is hardened due to the incident light, while the area not affected by the light is removed during developing. The light-hardened surface of a negative working plate is therefore oleophilic and accepts printing ink, while the non-image area that used to be coated with the coating removed by the developer is desensitized and therefore hydrophilic.

Photosensitive mixtures have been used for years in photopolymerizable compositions for the production of photosensitive materials such as e.g. printing plate precursors. However, an improved sensitivity in particular in the near UV and the visible spectral range is required for new and advanced applications (e.g. exposure by means of lasers) so that the exposure time can be shortened. From an economic point of view it is also important that low-intensity radiation sources can be used, which are less expensive and more reliable than high-intensity radiation sources. Therefore, efforts have been made for some time to increase the sensitivity of photosensitive mixtures to be used in photopolymerizable compositions.

DE-A-3021599 discloses radiation-sensitive compositions comprising ethylenically unsaturated monomers as well as a 2-(halogenomethyl-phenyl)-4-halogen-oxazole derivative as photoinitiator. However, the efficiency of the photoinitiator is insufficient.

EP-A-0 741 333 describes photopolymerizable compositions which in addition to ethylenically unsaturated monomers and organic binders comprise a combination of an optical brightener and a photoinitiator selected from acyl and diacyl phosphine oxides. As optical brighteners, those comprising a stilbene, triazine, thiazole, benzoxazole, coumarin, xanthene, triazole, oxazole, thiophene or pyrazoline unit are listed. However, based on today's standards, these photopolymerizable compositions do not exhibit sufficient sensitivity.

U.S. Pat No. 4,181,531 and U.S. Pat. No. 4,271,260 describe positive working systems containing 1,4-dihydropyridine derivatives and exhibiting sensitivity to UV light.

The use of 1,4-dihydropyridines in radiation-sensitive systems is also known from U.S. Pat. No. 6,143,471. In this document, 1,4-dihydropyridines are used as solvent inhibitors for polymers in positive working IR-sensitive compositions.

In US-B-6,291,143 1,4-dihydropyridines are used as photoreduction agents for dyes (such as IR dyes) in laser thermo-transfer systems. The resulting pyridinium salts furthermore function as cross-linking agents for hydroxy-functionalized resins in this system.

Since negative working systems, i.e. cross-linked plates, are more resistant to printing chamber chemicals than positive working systems, negative working systems are preferred if a high degree of chemical resistance is desired.

Negative working systems containing 1,4-dihydropyridines are described in DD-A-287 796. The photopolymerizable compositions disclosed in this document comprise an onium compound as coinitiator. The sensitivity obtained with these systems cannot by far meet the requirements of today's printing plates.

It is the object of the present invention to provide negative working radiation-sensitive compositions resulting in radiation-sensitive elements exhibiting high photosensitivity in combination with good storage stability, and—in the case of printing plates—yielding a large number of copies on the printing machine.

This object is achieved by a radiation-sensitive composition comprising
(a) one or more types of monomers and/or oligomers and/or polymers, each comprising at least one ethylenically unsaturated group accessible to a free-radical polymerization,
(b) at least one sensitizer,
(c) at least one coinitiator capable of forming free radicals together with the sensitizer (b) and selected from hexaarylbiimidazoles; and
(d) optionally one or more components selected from alkali-soluble binders, dyes, exposure indicators, plasticizers, chain transfer agents, leuco dyes, surfactants, inorganic fillers and thermopolymerization inhibitors,
   characterized in that the at least one sensitizer is a 1,4-dihydropyridine derivative of the formula (I) 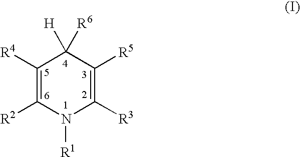
   wherein

R¹ is selected from a hydrogen atom, —C(O)OR⁷, an optionally substituted alkyl group, an optionally substituted aryl group and an optionally substituted aralkyl group,

R² and R³ are independently selected from optionally substituted alkyl groups, optionally substituted aryl groups, CN and a hydrogen atom,

R⁴ and R⁵ are independently selected from —C(O)OR⁷, —C(O)R⁷, 13 C(O)NR⁸R⁹ and CN,

or R² and R⁴ together form an optionally substituted phenyl ring or a 5- to 7-membered carbocyclic or heterocyclic ring, wherein the unit 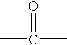
is present in the carbocyclic or heterocyclic ring adjacent to position 5 of the 1,4- dihydropyridine ring and wherein the carbocyclic or heterocyclic ring optionally comprises additional substituents,

or both R² and R⁴ as well as R³ and R⁵ form either optionally substituted phenyl rings or 5- to 7-membered carbocyclic or heterocyclic rings, wherein the unit 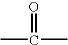
is present in the carbocyclic or heterocyclic rings adjacent to positions 3 and 5 of the dihydropyridine ring and wherein the carbocyclic or heterocyclic rings optionally comprise additional substituents,

or one of the pairs R²/R⁴ and R³/R⁵ forms a 5- to 7-membered carbocyclic or heterocyclic ring, wherein the unit 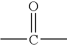
is present in the carbocyclic or heterocyclic ring adjacent to position 5 or 3 of the dihydropyridine ring and wherein the carbocyclic or heterocyclic ring optionally comprises additional substituents and the other pair forms an optionally substituted phenyl ring,

or R² and R¹ or R³ and R¹ form a 5- to 7-membered heterocyclic ring which can optionally comprise one or more substituents and which, in addition to the nitrogen atom it shares with the 1,4-dihydropyridine ring, optionally comprises additional nitrogen atoms, —NR¹³ groups, —S— or —O—,

R¹³ is selected from a hydrogen atom, an alkyl group, aryl group arid aralkyl group,

R⁶ is selected from an alkyl group optionally substituted with a halogen atom or a —C(O) group, an optionally substituted aryl group, an optionally substituted aralkyl group, an optionally substituted heterocyclic group and the group

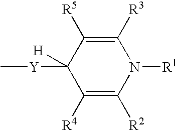

Y is an alkylene group or an arylene group,

R⁷ is a hydrogen atom, aryl group, aralkyl group or alkyl group, wherein the alkyl group and the alkyl unit of the aralkyl group optionally comprise one or more C—C double and/or C—C triple bonds,

and R⁸ and R⁹ are independently selected from a hydrogen atom, an optionally substituted alkyl group, an optionally substituted aryl group and an optionally substituted aralkyl group,

provided that the 1,4-dihydropyridine derivative of formula (I) does not contain any nitro groups bonded to an aromatic ring.

Unless defined otherwise, the term “alkyl group” as used in the present invention refers to a straight-chain, branched or cyclic saturated hydrocarbon group which preferably comprises 1 to 18 carbon atoms, more preferably 1 to 10 carbon atoms and especially preferred 1 to 6 carbon atoms. The alkyl group can optionally comprise one or more substituents (preferably 0 or 1 substituent) selected for example from halogen atoms (fluorine, chlorine, bromine, iodine), CN, NR¹³ ₂, C(O)OR¹³ and OR¹³ (R¹³ independently represents a hydrogen atom, an alkyl group, aryl group or aralkyl group). The above definition also applies to the alkyl unit of an aralkyl group and an alkylene group.

Unless defined otherwise, the term “aryl group” as used in the present invention refers to an aromatic carbocyclic group with one or more fused rings, which preferably comprises 6 to 14 carbon atoms. The aryl group can optionally comprise one or more substituents (preferably 0 to 3) selected for example from halogen atoms, alkyl groups, alkoxy groups, CN, NR¹³₂, SO₃H, COOR¹³ and OR¹³ (wherein each R¹³ is independently selected from hydrogen, alkyl, aryl and aralkyl). The above definition also applies to the aryl unit of an aralkyl group and an arylene group. Preferred examples are a phenyl group and a naphthyl group, which can optionally be substituted.

As referred to in the present invention, a fused ring or ring system indicates a ring that shares two atoms with the ring to which it is fused.

Unless defined otherwise, the term “heterocyclic group” as used in the present invention refers to a 5- to 7-membered (preferably 5- or 6-membered) saturated, unsaturated (non-aromatic) or aromatic ring, wherein one or more ring carbon atoms are replaced with heteroatoms selected from N, NR¹³, S and O (preferably N or NR¹³). The heterocyclic ring can optionally comprise one or more substituents, selected for example from alkyl groups, aryl groups, aralkyl groups, halogen atoms, —OR¹³, —NR¹³₂, —C(O)OR¹³, C(O)NR¹³₂ and CN (wherein each R¹³ is independently selected from hydrogen, alkyl, aryl and aralkyl). It goes without saying that due to the given basic structures (I) and (la) to (Ig), not every heterocyclic ring can be saturated or unsaturated or aromatic.

As referred to in the present invention, a carbocyclic ring is a 5- to 7-membered (preferably 5- or 6-membered) saturated or unsaturated ring. The carbocyclic ring can optionally comprise one or more substituents, selected for example from alkyl groups, aryl groups, aralkyl groups, halogen atoms, CN, —NR¹³₂, —C(O)OR¹³ , —C(O)NR¹³₂ and —OR¹³ (wherein R¹³ is as defined above). It goes without saying that due to the given basic structures (I) and (la) to (Ig), not every carbocyclic ring can be unsaturated or saturated.

All monomers, oligomers and polymers which are free-radical polymerizable and comprise at least one C—C double bond can be used as ethylenically unsaturated monomers, oligomers and polymers. Monomers, oligomers and polymers with C—C triple bonds can also be used, but they are not preferred. Suitable compounds are well known to the person skilled in the art and can be used in the present invention without any particular limitations. Esters of acrylic and methacrylic acids, itaconic acid, crotonic acid, isocrotonic acid, maleic acid and fumaric acid with one or more unsaturated groups in the form of monomers, oligomers or prepolymers are preferred. They may be present in solid or liquid form, with solid and highly viscous forms being preferred. Compounds suitable as monomers include for instance trimethylol propane triacrylate and -methacrylate, pentaerythritol triacrylate and -methacrylate, dipentaerythritol monohydroxy pentaacrylate and -methacrylate, dipentaerythritol hexaacrylate and -methacrylate, pentaerythritol tetraacrylate and -methacrylate, di(trimethylol propane) tetraacrylate and -methacrylate, diethylene glycol diacrylate and -methacrylate, triethylene glycol diacrylate and -methacrylate or tetraethylene glycol diacrylate and -methacrylate. Suitable oligomers and/or prepolymers are for example urethane acrylates and methacrylates, epoxide acrylates and methacrylates, polyester acrylates and methacrylates, polyether acrylates and methacrylates or unsaturated polyester resins.

In addition to monomers and/or oligomers, use can also be made of polymers comprising free-radical polymerizable C—C double bonds in the main or side chains. Examples thereof include reaction products of maleic acid anhydride olefin copolymers and hydroxyalkyl(meth)acrylates (cf. e.g. DE-A-4311738); (meth)acrylic acid polymers, partially or fully esterified with allyl alcohol (cf. e.g. DE-A-3332640); reaction products of polymeric polyalcohols and isocyanato(meth)acrylates; unsaturated polyesters; (meth)acrylate-terminated polystyrenes, poly(meth)acrylic acid ester, poly(meth)acrylic acids, poly(meth)acrylamides; (meth)acrylic acid polymers, partially or fully esterified with epoxides comprising free-radical polymerizable groups; and polyethers. In this connection, the prefix “(meth)” indicates that both derivatives of acrylic acid and of methacrylic acid can be used.

Additional suitable C—C unsaturated free-radical polymerizable compounds are described e.g. in EP-A-1 176 007.

It is of course possible to use different kinds of monomers, oligomers or polymers in the mixture; furthermore, mixtures of monomers and oligomers and/or polymers can be used in the present invention, as well as mixtures of oligomers and polymers. The free-radical polymerizable monomers, oligomers or polymers are preferably present in an amount of 5 to 95 wt.-%; if monomers/oligomers are used, especially preferred 20 to 85 wt.-%, based on the dry layer weight of a radiation-sensitive coating prepared from the radiation-sensitive composition of the present invention. As used in the present invention, the term “dry layer weight of the radiation-sensitive coating” is therefore synonymous with the term “solids of the radiation-sensitive composition”.

A sensitizer as referred to in the present invention is a compound which can absorb radiation when it is exposed but which cannot by itself, i.e. without the addition of coinitiators, form free radicals.

In the present invention, one sensitizer or a mixture of two or more can be used.

In the present invention, a 1,4-dihydropyridine compound of formula (I) is used as sensitizer 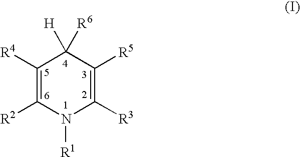
wherein

R¹ is selected from a hydrogen atom, —C(O)OR⁷, an optionally substituted alkyl group, an optionally substituted aryl group and an optionally substituted aralkyl group,

R² and R³ are independently selected from optionally substituted alkyl groups, optionally substituted aryl groups, CN and a hydrogen atom,

R⁴ and R⁵ are independently selected from —C(O)OR⁷, —C(O)R⁷, —C(O)NR⁸R⁹ and CN,

or R² and R⁴ together form an optionally substituted phenyl ring or a 5- to 7-membered carbocyclic or heterocyclic ring, wherein the unit 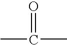
is present in the carbocyclic or heterocyclic ring adjacent to position 5 of the dihydropyridine ring and wherein the carbocyclic or heterocyclic ring optionally comprises additional substituents,

or both R² and R⁴ as well as R³ and R⁵ form either optionally substituted phenyl rings or 5- to 7-membered carbocyclic or heterocyclic rings, wherein the unit 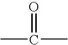
is present in the carbocyclic or heterocyclic rings adjacent to positions 3 and 5 of the dihydropyridine ring and wherein the carbocyclic or heterocyclic rings optionally comprise additional substituents,

or one of the pairs R²/R⁴ and R³/R⁵ forms a 5- to 7-membered carbocyclic or heterocyclic ring, wherein the unit 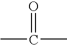
is present in the carbocyclic or heterocyclic ring adjacent to position 5 or 3 of the dihydropyridine ring and wherein the carbocyclic or heterocyclic ring optionally comprises additional substituents and the other pair forms an optionally substituted phenyl ring,

or R² and R^{1 =l or R}³ and R¹ form a 5- to 7-membered heterocyclic ring which can optionally comprise one or more substituents and which, in addition to the nitrogen atom it shares with the 1,4-dihydropyridine ring, optionally comprises additional nitrogen atoms, —NR¹³ groups, —S— or —O—,
R¹³ is selected from a hydrogen atom, an alkyl group, aryl group and aralkyl group, R⁶ is selected from an alkyl group optionally substituted with a halogen atom or a —C(O) group, an optionally substituted aryl group, an optionally substituted aralkyl group, an optionally substituted heterocyclic group and the group 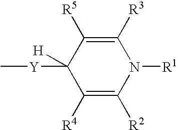
Y is an alkylene group or an arylene group,

R⁷ is a hydrogen atom, aryl group, aralkyl group or alkyl group, wherein the alkyl group and the alkyl unit of the aralkyl group optionally comprise one or more C—C double and/or C—C triple bonds,

and R⁸ and R⁹ are independently selected from a hydrogen atom, an optionally substituted alkyl group, an optionally substituted aryl group and an optionally substituted aralkyl group,

provided that the 1,4-dihydropyridine derivative of formula (I) does not contain any nitro groups bonded to an aromatic ring.

According to a preferred embodiment, R¹ is a hydrogen atom.

If R² and R³ do not form rings with adjacent substituents, they are preferably independently selected from C₁-C₅ alkyl groups or aryl groups.

If R⁴ and R⁵ do not form rings with adjacent substituents, they are preferably independently selected from —C(O)OR⁷ .

R⁶ is preferably selected from C₁-C₅ alkyl groups or aryl groups.

R⁷ is preferably selected from C₁-C₅ alkyl groups and it is especially preferred that it represents a methyl group.

According to one embodiment, the substitution of the 1,4-dihydropyridine ring with R²/R⁴ and R³/R⁵ is symmetrical, i.e. R²=R³ and R⁴=R⁵.

According to a preferred embodiment, R² and R³ are independently selected from optionally substituted alkyl groups, optionally substituted aryl groups, CN and a hydrogen atom, and R⁴ and R⁵ are independently selected from —C(O)OR⁷, —C(O)R⁷, —C(O)NR⁸R⁹ and CN.

Further suitable sensitizers are 1,4-dihydropyridine derivatives of formula (Ia) 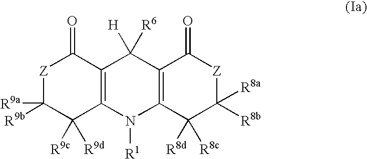
wherein R¹ and R⁶ are as defined above,

the groups R^{8a} to R^{8d} and R^{9a} to R^{9 d} are independently selected from a hydrogen atom, alkyl groups and aryl groups, wherein two groups R⁹ and/or two groups R⁸ of adjacent ring carbon atoms can also form a saturated or unsaturated carbocyclic or heterocyclic ring or fused aromatic ring together,

each Z is independently selected from CR¹³₂, O, S and NR¹³ and

each R¹³ independently represents a hydrogen atom, alkyl, aralkyl or aryl group, of formula (Ib) 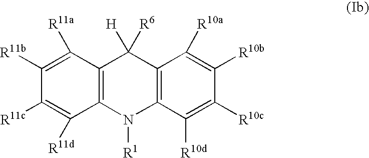
wherein R¹ and R⁶ are as defined above, and

R^{10a} to R^{10d} and R^{11a} to R^{11d} are independently selected from a hydrogen atom, alkyl groups, aryl groups, aralkyl groups, halogen atoms (fluorine, chlorine, bromine, iodine), CN, NR¹³₂, C(O)OR¹³ and OR¹³ (each R¹³ independently represents a hydrogen atom, an alkyl group, aryl group or aralkyl group), wherein two groups R¹¹ and/or two groups R¹⁰ of adjacent ring carbon atoms can also form an unsaturated carbocyclic or heterocyclic ring or fused aromatic ring together,

of formula (Ic) 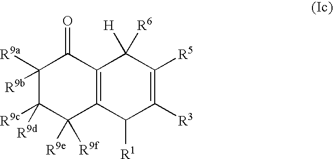
wherein R¹, R³, R⁵ and R⁶ are as defined above and the groups R^{9a} to R^{9f} are independently selected from a hydrogen atom, alkyl groups, aryl groups, aralkyl groups, halogen atoms (fluorine, chlorine, bromine, iodine), CN, NR¹³₂, C(O)OR¹³ and OR¹³ (R¹³ independently represents a hydrogen atom, an alkyl group, aryl group or aralkyl group), wherein two groups R⁹ of adjacent ring carbon atoms can also form a saturated or unsaturated carbocyclic or heterocyclic ring or fused aromatic ring together,

of formula (Id) 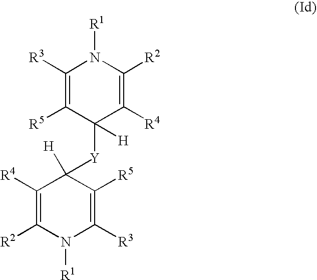
wherein each R¹, R², R³, R⁴ and R⁵ independently is as defined above and Y is selected from alkylene and arylene,

of formula (Ie) 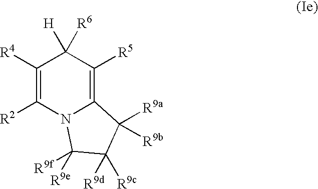
wherein R², R⁴, R⁵ and R⁶ are as defined above and groups R^{9a} to R^{9f} are defined as are groups R^{9a} to R^{9d} of formula (Ia) above,

of formula (If) 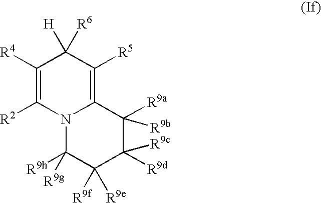
wherein R², R⁴, R⁵ and R⁶ are as defined above and groups R^{9a} to R^{9h} are defined as are groups R^{9a} to R^{9d} of formula (Ia) above

and of formula (Ig) 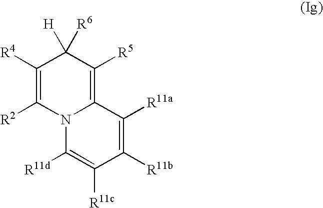
wherein R², R⁴, R⁵ and R⁶ are as defined above and the groups R^{11a} to R^{11d} are independently selected from a hydrogen atom, alkyl groups, aryl groups, aralkyl groups, halogen atoms (fluorine, chlorine, bromine, iodine), CN, NR¹³₂, C(O)OR¹³ and OR¹³ (R¹³ independently represents a hydrogen atom, an alkyl group, aryl group or aralkyl group), wherein two adjacent groups R¹¹ of adjacent ring carbon atoms can also form an unsaturated carbocyclic or heterocyclic ring or fused aromatic ring together.

It goes without saying that the number of groups R⁸ or R⁹ in formulas (Ia), (Ic), (Ie) and (If) is reduced if two groups R⁸ or R⁹ of adjacent ring carbon atoms together form a fused aromatic ring.

In the 1,4-dihydropyridine derivatives of formula (Ia), R¹ is preferably a hydrogen atom, R⁶ is a methyl or phenyl group and Z is preferably O or CH₂; the substituents R^{8a} to R^{8d} and R^{9a} to R^{9d} are independently preferably selected from hydrogen atoms and methyl groups. Of the derivatives of formula (Ia) those with symmetrical substitution at the dihydropyridine ring are especially preferred.

In the derivatives of formula (Ib), R¹ is preferably a hydrogen atom and R⁶ is preferably a methyl or phenyl group. The substituents R^{10a} to R^{10d} and R^{11a} to R^{11d} are independently preferably selected from Cₗ-C₅ alkyl groups, OR¹³ and halogen atoms; a symmetrical substitution of the two aromatic rings is especially preferred.

In the 1,4-dihydropyridine derivatives of formula (Ic), R¹ is preferably a hydrogen atom, R⁶ is preferably a methyl or phenyl group, R³ is preferably a methyl group and R⁵ is preferably C(O)OR⁷ (wherein R⁷ is as defined above). The substituents R^{9a} to R^{9f} are independently preferably selected from C₁-C₅ alkyl groups. A methyl group is especially preferred.

In the derivatives of formula (Id), Y is preferably a 1,4-phenylene or 1,2-ethylene group. Furthermore, it is preferred that both groups R¹ be the same, both groups R² be the same, both groups R³ be the same, both groups R⁴ be the same and both groups R⁵ be the same; the preferred definitions given with respect to formula (I) apply to all groups R¹ to R⁵.

In the derivatives of formula (Ie), R² is preferably C₁-C₅ alkyl, R⁴ is preferably —C(O)OR⁷, R⁵ is preferably C(O)OR⁷ and R⁶ is preferably C₁-C₅ alkyl or phenyl groups (R⁷ is as defined above). The substituents R^{9a} to R^{9f} are preferably independently selected from C₁-C₅ alkyl groups.

In the derivatives of formula (If), R² is preferably C₁-C₅ alkyl, R⁴ is preferably C(O)OR⁷, R⁵ is preferably C(O)OR⁷ and R⁶ is preferably a C₁-C₅ alkyl or a phenyl group (wherein R⁷ is as defined above). The substituents R^{9a} to R^{9h} are preferably independently selected from C₁-C₅ alkyl groups.

In the derivatives of formula (Ig), R² is preferably C₁-C₅ alkyl, R⁴ is preferably C(O)OR⁷, R⁵ is preferably C(O)OR⁷ and R⁶ is preferably a C₁-C₅ alkyl or a phenyl group. The substituents R¹¹ are preferably independently selected from C₁-C₅ alkyl groups.

Of the 1,4-dihydropyridine derivatives of formulas (Ia) to (Ig) those of formulas (Ia) and (Id) are especially preferred.

The 1,4-dihydropyridine derivatives used in the present invention can be prepared according to processes well known to the person skilled in the art, such as the Hantzsch synthesis. As an example, reference is made to J. Org. Chem. 30 (1965), p. 1914 et seqq., and Angew. Chem. [Applied Chemistry] (Intern.) 20 (1981), p. 762 et seqq.; the processes described therein can also be used for the synthesis of 1,4-dihydropyridines not explicitly disclosed therein by varying the starting compounds accordingly.

1,4-Dihydropyridine derivatives with nitro groups bonded to an aromatic ring are not suitable for the present invention since they may act as polymerization inhibitors.

The amount of sensitizer(s) is not particularly restricted; however, it is preferably in the range of 0.2 to 25. wt.-% based on the solids content or the dry layer weight of a coating produced from the composition, preferably 0.5 to 15 wt.-%.

A coinitiator as referred to in the present invention is a compound that forms free radicals together with the sensitizers used according to the present invention. According to the present invention, the coinitiators are selected from 2,2′,4,4′,5,5′-hexaarylbiimidazoles (in the following simply referred to as hexaarylbiimidazoles).

Suitable hexaarylbiimidazoles are for example represented by the formula (II) below: 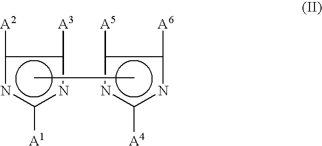
wherein A¹-A⁶ are substituted or unsubstituted C₅-C₂₀ aryl groups which are identical or different from each other and in whose rings one or more carbon atoms can optionally be substituted by heteroatoms selected from O, N and S. Suitable substituents for the aryl groups are those that do not inhibit the light-induced dissociation to triarylimidazolyl radicals, e.g. halogen atoms (fluorine, chlorine, bromine, iodine), —CN, C₁-C₆ alkyl (optionally with one or more substituents selected from halogen atoms, —CN and —OH), C₁-C₆ alkoxy, C₁-C₆ alkylthio, (C₀-C₆ alkyl) sulfonyl.

Preferred aryl groups are substituted and unsubstituted phenyl, biphenyl, naphthyl, pyridyl, furyl and thienyl groups. Especially preferred are substituted and unsubstituted phenyl groups, and particularly preferred are halogen-substituted phenyl groups.

Examples include:
2,2′-Bis(bromophenyl)-4,4′,5,5′-tetraphenylbiimidazole,
2,2′-bis(p-carboxyphenyl)-4,4′,5,5″-tetraphenylbiimidazole,
2,2′-bis(o-chlorophenyl)-4,4′,5,5′-tetrakis(p-methoxyphenyl)-biimidazole,
2,2′-bis(p-chlorophenyl)-4,4′,5,5′-tetrakis(p-methoxyphenyl)-biimidazole,
2,2′-bis(p-cyanophenyl)-4,4′5,5′-tetrakis(p-methoxyphenyl)-biimidazole,
2,2′-bis(2,4-dichlorophenyl)-4,4′,5,5′-tetraphenylbiimidazole,
2,2′-bis(2,4-dimethoxyphenyl)-4,4′,5,5′-tetraphenylbiimidazole,
2,2′-bis(o-ethoxyphenyl)-4,4′,5,5′-tetraphenylbiimidazole,
2,2′-bis(m-fluorophenyl)-4,4′,5,5′-tetraphenylbiimidazole,
2,2′-bis(o-fluorophenyl)-4,4′,5,5′-tetraphenylbiimidazole,
2,2′-bis(p-fluorophenyl)-4,4′,5,5′-tetraphenylbiimidazole,
2,2′-bis(o-hexoxyphenyl)-4,4′,5,5′-tetraphenylbiimidazole,
2,2′-bis(o-hexylphenyl)-4,4′,5,5′-tetrakis(p-methoxyphenyl)-biimidazole,
2,2′-bis(3,4-methylenedioxyphenyl)-4,4′,5,5′-tetraphenylbiimidazole,
2,2′-bis(o-chlorophenyl)-4,4′,5,5′-tetrakis(m-methoxyphenyl)biimidazole,
2,2′-bis(o-chlorophenyl)-4,4′,5,5′-tetrakis[m-(betaphenoxy-ethoxyphenyl)]biimidazole,
2,2′-bis(2,6-dichlorophenyl)-4,4′,5,5′-tetraphenylbiimidazole,
2,2′-bis(o-methoxyphenyl)-4,4′,5,5′-tetraphenylbiimidazole,
2,2′-bis(p-methoxyphenyl)-4,4′=l -bis(o-methoxyphenyl)-5,5′-diphenylbiimidazole,
2,2′-bis(o-nitrophenyl)-4,4′,5,5′-tetraphenylbiimidazole,
2,2′-bis(p-phenylsulfonylphenyl)-4,4′,5,5′-tetraphenyl-blimidazole,
2,2′-bis(p-sulfamoylphenyl)-4,4′,5,5′-tetraphenylbiimidazole,
2,2′-bis(2,4,5-trimethylphenyl)-4,4′,5,5′-tetraphenylbiimidazole,
2,2′-di-4-biphenylyl-4,4′,5,5′-tetraphenylbiimidazole,
2,2′-di-1-naphthyl-4,4′,5,5′-tetrakis(p-methoxyphenyl)-biimidazole,
2,2′-di-9-phenanthryl-4,4′,5,5′-tetrakis(p-methoxyphenyl)-biimidazole,
2,2′-diphenyl-4,4′,5,5′-tetra-4-biphenylylbiimidazole,
2,2′-diphenyl-4,4′,5,5′-tetra-2,4-xylylbiimidazole,
2,2′-di-3-pyridyl-4,4′,5,5′-tetraphenylbiimidazole,
2,2′-di-3-thienyl-4,4′,5,5′-tetraphenylbiimidazole,
2,2′-di-o-tolyl-4,4′,5,5′-tetraphenylbiimidazole,
2,2′-di-p-tolyl-4,4′-di-o-tolyl-5,5′-diphenylbiimidazole,
2,2′-di-2,4-xylyl-4,4′,5,5′-tetraphenylbiimidazole,
2,2′,4,4′,5,5′-hexakis(p-benylthiophenyl)biimidazole,
2,2′,4,4′,5,5′-hexa-1-naphthylbiimidazole,
2,2′,4,4′,5,5′-hexaphenylbiimidazole,
2,2′-bis(2-nitro-5-methoxyphenyl)-4,4′,5,5′-tetraphenylbiimidazole,
2,2′-bis(o-nitrophenyl)-4,4′,5,5′-tetrakis(m-methoxyphenyl)biimidazole,
2,2′-bis(2-chloro-5-sulfophenyl)-4,4′,5,5′-tetraphenylbiimidazole,
2,2′,5-tris(2-chlorophenyl)-4-(3,4-dimethoxyphenyl)-4,5′diphenylbiimidazole,
2,2′-bis(o-chlorophenyl)-4,4′,5,5′-tetraphenylbiimidazole,
2,2′-bis(o-chlorophenyl)-4,4′,5,5′-tetra(p-fluorophenyl)biimidazole,
2,2′-bis(o-bromophenyl)-4,4′,5,5′-tetra(p-iodophenyl)biimidazole,
2,2′-bis(o-chlorophenyl)-4,4′,5,5′-tetra(p-chlotonaphthyl)biimidazole,
2,2′-bis(o-chlorophenyl)-4,4′,5,5′-tetra(p-chlorophenyl)biimidazole,
2,2′-bis(o-bromophenyl)-4,4′,5,5′-tetra(p-chloro-p-methoxyphenyl)biimidazole,
2,2′-bis(o-chlorophenyl)-4,4′,5,5′-tetra(o,p-dichlorophenyl)biimidazole,
2,2′-bis(o-chlorophenyl)-4,4′,5,5′-tetra(o,p-dibromophenyl)biimidazole,
2,2′-bis(o-bromophenyl)-4,4′,5,5′-tetra(o,p-dichlorophenyl)biimidazole or
2,2′-bis(o,p-dichlorophenyl)-4,4′,5,5′,-tetra(o,p-dichlorophenyl)biimidazole;
   however, the invention is not restricted to those compounds.

Suitable hexaarylbiimidazoles are for example described in U.S. Pat. No. 4,565,769 and U.S. Pat. No. 3,445,232 and can be prepared according to known processes, such as e.g. the oxidative dimerization of triarylimidazoles.

In the present invention, one hexaarylbiimidazole or a mixture of several can be used as coinitiator.

The amount of coinitiator(s) is not particularly restricted; however, it is preferably in the range of 0.2 to 25 wt.-%, based on the dry layer weight, especially preferred 0.5 to 15 wt.-%.

Optionally, the radiation-sensitive coating of the present invention can also comprise an alkali-soluble binder or a mixture of such binders. The binder is preferably selected from polyvinyl acetals, acrylic polymers, polyurethanes and copolymers thereof. It is preferred that the binder contain acid groups, especially preferred carboxyl groups. Most preferred are acrylic polymers. Binders with acid groups preferably have acid numbers in the range of 20 to 180 mg KOH/g polymer. Optionally, the binder can comprise groups that are capable of undergoing a cycloaddition (e.g. photocycloaddition). The amount of binder is not particularly restricted and is preferably in the range of 0 to 90 wt.-%, especially preferred 5 to 60 wt.-%.

The radiation-sensitive coating can optionally also comprise small amounts of a thermopolymerization inhibitor. Suitable examples of inhibitors of an undesired thermopolymerization include hydroquinone, p-methoxyphenol, di-t-butyl-p-cresol, pyrrogallol, t-butylcatechol, benzoquinone, 4,4′-thio-bis-(3-methyl-6-t-butylphenol), 2,2′-methylene-bis-(4-methyl-6-t-butylphenol) and N-nitrosophenylhydroxylamine salts. The amount of non-absorbable thermopolymerization inhibitor in the radiation-sensitive coating is preferably 0 to 5 wt.-%, based on the dry layer weight, especially preferred 0.01 to 2 wt.-%. Such inhibitors are often introduced into the radiation-sensitive coating via commercial monomers or oligomers and are therefore not expressly mentioned.

Furthermore, the radiation-sensitive coating of the present invention can comprise dyes or pigments for coloring the layer. It goes without saying that the colorant has to be selected such that the hexaarylbiimidazole is not sensitized and broken down; the person skilled in the art can determine suitable colorants by means of simple experiments or calculations on the basis of redox data. Examples of colorants include e.g. phthalocyanine pigments, azo pigments, carbon black, titanium dioxide, azo dyes, triarylmethane dyes, anthraquinone dyes and cyanine dyes. The use of pigments is preferred since the phase separation suppresses the sensitization of the hexaarylbiimidazole. The amount of colorant is preferably 0 to 20 wt.-%, based on the dry layer weight, especially preferred 0.5 to 10 wt.-%.

For improving the physical properties of the hardened layer, the radiation-sensitive coating can additionally comprise further additives such as plasticizers. Suitable plasticizers include e.g. dibutyl phthalate, dioctyl phthalate, didodecyl phthalate, dioctyl adipate, dibutyl sebacate, triacetyl glycerin und tricresyl phosphate. The amount of plasticizer is not particularly restricted, however, it is preferably 0 to 10 wt.-%, based on the dry layer weight, especially preferred 0.25 to 5 wt.-%.

The radiation-sensitive coating can also comprise known chain transfer agents such as e.g. mercaptobenzimidazole, 2-mercaptobenzthiazole, 2-mercaptobenzoxazole and 3-mercaptotriazole. They are preferably used in an amount of 0 to 15 wt.-%, based on the dry layer weight, especially preferred 0.5 to 5 wt.-%.

Furthermore, the radiation-sensitive coating can comprise leuco dyes such as e.g. leuco crystal violet and leucomalachite green. They are preferably present in an amount of 0 to 10 wt.-%, based on the dry layer weight, especially preferred 0.5 to 5 wt.-%.

Additionally, the radiation-sensitive coating can comprise surfactants. Suitable surfactants include siloxane-containing polymers, fluorine-containing polymers and polymers with ethylene oxide and/or propylene oxide groups. They are preferably present in an amount of 0 to 10 wt.-%, based on the dry layer weight, especially preferred 0.2 to 5 wt.-%.

Further optional components of the radiation-sensitive coating include inorganic fillers such as e.g. Al₂O₃ and SiO₂. They are preferably present in an amount of 0 to 20 wt.-%, based on the dry layer weight, especially preferred 0.1 to 5 wt.-%.

Exposure indicators, such as e.g. 4-phenylazodiphenylamine, can also be present as optional components of the radiation-sensitive coating; they are preferably present in an amount of 0 to 5 wt.-%, especially preferred 0 to 2 wt.-%, based on the dry layer weight.

The radiation-sensitive elements of the present invention can for example be printing plate precursors (in particular precursors of lithographic printing plates), printed circuit boards for integrated circuits or photomasks.

A dimensionally stable plate or foil-shaped material is preferably used as a substrate in particular in the production of printing plate precursors. Preferably, a material is used as dimensionally stable plate or foil-shaped material that has already been used as a substrate for printing matters. Examples of such substrates include paper, paper coated with plastic materials (such as polyethylene, polypropylene, polystyrene), a metal plate or foil, such as e.g. aluminum (including aluminum alloys), zinc and copper plates, plastic films made e.g. from cellulose diacetate, cellulose triacetate, cellulose propionate, cellulose acetate, cellulose acetatebutyrate, cellulose nitrate, polyethylene terephthalate, polyethylene, polystyrene, polypropylene, polycarbonate and polyvinyl acetate, and a laminated material made from paper or a plastic film and one of the above-mentioned metals, or a paper/plastic film that has been metallized by vapor deposition. Among these substrates, an aluminum plate or foil is especially preferred since it shows a remarkable degree of dimensional stability, is inexpensive and furthermore exhibits excellent adhesion to the coating. Furthermore, a composite film can be used wherein an aluminum foil has been laminated onto a polyethylene terephthalate film.

A metal substrate, in particular an aluminum substrate, is preferably subjected to at least one treatment selected from graining (e.g. by brushing in a dry state or brushing with abrasive suspensions, or electrochemical graining, e.g. by means of a hydrochloric acid electrolyte), anodizing (e.g. in sulfuric acid or phosphoric acid) and hydrophilizing.

In order to improve the hydrophilic properties of the surface of the metal substrate that has been grained and optionally anodized in sulfuric acid or phosphoric acid, the metal substrate can be subjected to an aftertreatment with an aqueous solution of sodium silicate, calcium zirconium fluoride, polyvinylphosphonic acid or phosphoric acid. Within the framework of the present invention, the term “substrate” also encompasses an optionally pre-treated substrate exhibiting, for example, a hydrophilizing layer on its surface.

The details of the above-mentioned substrate pre-treatment are known to the person skilled in the art.

For producing a radiation-sensitive element, the radiation-sensitive composition of the present invention is applied to the surface of the substrate by means of common coating processes (e.g. spin coating, dip coating, coating by means of doctor blades). It is also possible to apply the radiation-sensitive composition on both sides of the substrate; however, for the elements of the present invention, it is preferred that the radiation-sensitive coating be only applied to one side of the substrate.

For this purpose, the radiation-sensitive composition comprises one or several organic solvents.

Suitable solvents include low alcohols (e.g. methanol, ethanol, propanol and butanol), glycolether derivatives (e.g. ethylene glycol monomethylether, ethylene glycol dimethylether, propylene glycol monomethylether, ethylene glycol monomethylether acetate, ethylene glycol monoethylether acetate, propylene glycol monomethylether acetate, propylene glycol monoethylether acetate, ethylene glycol monoisopropylether acetate, ethylene glycol monobutylether acetate, diethylene glycol monomethylether, diethylene glycol monoethylether), ketones (e.g. diacetone alcohol, acetyl acetone, acetone, methyl ethyl ketone, cyclohexanone, methyl isobutyl ketone), esters (e.g. methyl lactate, ethyl lactate, acetic acid ethyl ester, 3-methoxypropyl acetate and butyl acetate), aromatics (e.g. toluene and xylene), cyclohexane, methoxymethoxyethanol, y-butyrolactone and dipolar aprotic solvents (e.g. THF, dimethylsulfoxide, dimethylformamide and N-methylpropyrrolidone). The solids content of the radiation-sensitive mixture to be applied depends on the coating method that is used and is preferably 1 to 50 wt.-%.

The additional application of a water-soluble oxygen-impermeable overcoat onto the radiation-sensitive layer can be advantageous. The polymers suitable for such an overcoat include, inter alia, polyvinyl alcohol, polyvinyl alcohol/polyvinyl acetate copolymers, polyvinyl pyrrolidone, polyvinyl pyrrolidone/polyvinyl acetate copolymers, polyvinyl methylethers, ring-opened copolymers of maleic acid anhydride and a comonomer such as methylvinylether, polyacrylic acid, cellulose ether, gelatin, etc.; polyvinyl alcohol is preferred. Preferably, the composition for the oxygen-impermeable overcoat is applied in the form of a solution in water or in a solvent miscible with water; in any case, the solvent is selected such that the radiation-sensitive coating already present on the substrate does not dissolve. The layer weight of the overcoat can e.g. be 0.1 to 6 g/m², preferably 0.5 to 6 g/m². However, the printing plate precursors according to the present invention show excellent properties even without an overcoat. The overcoat can also comprise matting agents (i.e. organic or inorganic particles with a particle size of 2 to 20 μm) which facilitate the planar positioning of the film during contact exposure. In order to improve adhesion of the overcoat to the radiation-sensitive layer, the overcoat can comprise adhesion promoters such as e.g. poly(vinylpyrrolidone), poly(ethyleneimine) and poly(vinylimidazole).

Suitable overcoats are described for example in WO 99/06890.

The thus produced radiation-sensitive elements are image-wise exposed in a manner known to the person skilled in the art with UV radiation (preferably 250 to 450 nm) and subsequently developed with a commercially available aqueous alkaline developer. Mercury lamps doped with a metal halide and diodes emitting UV light (UV-LED) can for example be used as a radiation source. UV laser diodes emitting UV radiation in the range of about 405 nm (e.g. 405±10 nm) are of particular interest as a radiation source. After image-wise exposure, i.e. prior to developing, a heat treatment can be carried out at 50 to 180° C., preferably 90 to 150° C. The developed elements can be treated with a preservative (“gumming”) using a common method. The preservatives are aqueous solutions of hydrophilic polymers, wetting agents and other additives.

For certain applications (e.g. in the case of printing plates), it is furthermore advantageous to increase the mechanical strength of the portions of the coating remaining after developing by subjecting them to a heat treatment (what is referred as “baking”) and/or a combination of baking and overall exposure (e.g. to UV light). For this purpose, prior to the treatment, the developed element is treated with a solution that protects the non-image areas such that the heat treatment does not cause these areas to accept ink. A solution suitable for this purpose is e.g. described in U.S. Pat. No. 4,355,096. Baking takes place at a temperature in the range of 150 to 250° C. However, elements as well as printing plates prepared from radiation-sensitive elements according to the present invention show excellent properties even without having been subjected to a heat treatment. When both baking and overall exposure are carried out, the two treatment steps can be performed simultaneously or one after the other.

The radiation-sensitive elements according to the present invention are characterized by excellent stability under yellow light conditions, a high degree of photosensitivity and excellent resolution in combination with good storage stability. In the case of printing plate precursors, the developed printing plates exhibit excellent abrasion resistance which allows a large number of copies.

The invention will be explained in more detail in the following examples.

### EXAMPLES

### Preparation Examples 1-3

0.2 moles methylacetoacetate (available from Aldrich), 0.1 moles of the aldehyde corresponding to the 4-substituent and 0.11 moles ammonium acetate were dissolved in 30 ml methanol. This mixture was refluxed for 3 hours. The precipitation formed after cooling was filtered off and dried in a vacuum oven for one day at 40° C. The products were then recrystallized in solvents or solvent mixtures as listed in Table 1. The 1,4-dihydropyridine structure was confirmed by UV spectra recorded in methanol (absorption wavelength λ and extinction coefficient ε, see Table 1).

TABLE 1

| | 1,4-Dihydropyridine | Solvent for | Melting point | λ [nm] |
|---|---|---|---|---|
| | derivative of formula (I) | recrystallization | [° C.] | ε [l/g × cm] |
| Preparation | R¹═H | methanol/water | 146-148 | 348 |
| Example 1 | R²═R³═CH₃; | (6/4) | | 30.2 |
| | R⁴═R⁵═CH₃OC(O)— | | | |
| | R⁶═ethyl | | | |
| Preparation | R¹═H | ethanol/water (2/1) | 190-192 | 352 |
| Example 2 | R²═R³═CH₃; | | | 23.1 |
| | R⁴═R⁵═CH₃OC(O)— | | | |
| | R⁶═phenyl | | | |
| Preparation | R¹═H | i-propanol | 200-201 | 348 |
| Example 3 | R²═R³═CH₃; | | | 26.1 |
| | R⁴═R⁵═CH₃OC(O)— | | | |
| | R⁶═4-N,N-dimethyl- | | | |
| | aminophenyl | | | |

### Preparation Example 4

### 3,3′,6,6′-Tetramethyl-9-phenyl-1,2,3,4,5,6,7,8,9,10-decahydroacridine-1,8-dione

5.3 g benzaldehyde, 14 g 5,5-dimethyl-1,3-cyclohexanedione (available from Aldrich) and 4.5 g ammonium acetate were dissolved in 35 ml methanol. This mixture was refluxed for 5 hours. The precipitation formed after cooling was filtered off, recrystallized in methanol and dried in a vacuum oven for one day at 40° C. Yield: 13.4 g (77%); melting point: 275-277° C.; λ=375 nm; ε=25.4 l/g×cm.

### Examples 1 to 4 and Comparative Examples 1 to 6

### Exposure with a Ga-Doped MH lamp

An electrochemically (in HCl) grained and anodized aluminum foil was subjected to a treatment with an aqueous solution of polyvinylphosphonic acid (PVPA) and after drying was coated with a solution as described in Table 2 and dried.

TABLE 2

| | | |
|---|---|---|
| 1.05 | g | of a 30% 1-methoxy-2-propanol solution of a terpolymer prepared by |
| | | polymerization of 470 parts by weight styrene, 336 parts by weight |
| | | methylmethacrylate and 193 parts by weight methacrylic acid |
| 0.1 | g | Kayamer PM-2 (1 mole phosphoric acid esterified with 1,5 moles hydroxyethyl- |
| | | methacrylate) |
| 0.20 | g | mercapto-1,2,4-triazole |
| 3.42 | g | of an 80% methyl ethyl ketone solution of a urethane acrylate prepared by |
| | | reacting Desmodur N100 ® (available from Bayer) with hydroxy ethyl acrylate |
| | | and pentaerythritol triacrylate; content of double bonds: 0.5 double bonds per |
| | | 100 g when all isocyanate groups have completely reacted with the acrylates |
| | | containing hydroxy groups |
| 0.39 | g | ditrimethylolpropane tetraacrylate |
| 2.18 | g | of a dispersion in 1-methoxy-2-propanol comprising 10 wt.-% copper |
| | | phthalocyanine and 5 wt.-% of a polyvinylacetal binder comprising 39.9 mole-% |
| | | vinyl alcohol, 1.2 mole-% vinyl acetate, 15.4 mole-% acetal derived from |
| | | acetaldehyde, 36.1 mole-% acetal groups derived from butyric aldehyde and 7.4 |
| | | mole-% acetal groups derived from 4-formylbenzoic acid |
| X | g | 1,4-dihydropyridine derivative (according to Table 3) |
| Y | g | coinitiator (according to Table 3) |
| 23 | ml | 1-methoxy-2-propanol |
| 16 | ml | methanol |
| 26 | ml | methyl ethyl ketone |

The solution was filtered, applied to the lithographic substrate and the coating was dried for 4 minutes at 90° C. The dry layer weight of the photopolymer layer was about 1.6 g/m².

An overcoat was applied to the resulting samples by coating them with an aqueous solution of poly(vinylalcohol) (Airvol 203 from Airproducts, degree of hydrolysis: 88%); after drying for 4 minutes at 90° C., the overcoat had a dry layer weight of about 2 g/m².

The printing plate precursor was exposed to the light of a Ga-doped MH lamp with an energy of 1.7 mJ/cm² in a vacuum frame using a gray scale having a tonal range of 0.15 to 1.95, wherein the density increments amounted to 0.15 (UGRA gray scale). Immediately after exposure, the plate was heated in an oven for 2 minutes at 90° C.

Then the exposed plate was treated for 30 seconds with a developer solution comprising the following components:
3.4 parts by weight Rewopol NLS 28® (available from REWO)
1.1 parts by weight diethanol amine
1.0 parts by weight Texapon 842® (available from Henkel)

0.6 parts by weight Nekal BX Paste® (available from BASF)

0.2 parts by weight 4-toluene sulfonic acid and

93.7 parts by weight water

Then the developer solution was again rubbed over the surface for another 30 seconds using a tampon and then the entire plate was rinsed with water. After this treatment, the exposed portions remained on the plate. For the assessment of its photosensitivity, the plate was blackened in a wet state with printing ink.

For the assessment of storage stability of the plates, the unexposed printing plate precursors were stored for 60 minutes in a 90° C. oven, then exposed and developed as described above (storage stability test).

For the preparation of a lithographic printing plate, a printing layer was applied to the aluminum foil, as explained above, exposed, heated, developed, and after rinsing with water, the developed plate was rubbed and gummed with an aqueous solution of 0.5% phosphoric acid and 6% gum arabic. The thus prepared plate was loaded in a sheet-fed offset printing machine and used for printing with an abrasive printing ink (Offset S 7184 available from Sun Chemical, containing 10% potassium carbonate).

The results are summarized in Table 3.

TABLE 3

| | Type and amount of | Type and amount of | | Gray scale¹⁾ after treatment | |
|---|---|---|---|---|---|
| Example | 1,4-dihydropyridine | coinitiator | Gray scale¹⁾ | for 60 min at 90° C.²⁾ | Printing results |
| 1 | 0.5 g | 0.17 g | 7/10 | 7/10 | no plate wear up to |
| | Preparation Example 1 | o-Cl-Habi³⁾ | | | 50,000 copies |
| 2 | 0.5 g | 0.17 g | 3/7 | 5/7 | no plate wear up to |
| | Preparation Example 2 | o-Cl-Habi³⁾ | | | 50,000 copies |
| 3 | 0.5 g | 0.17 g | 6/10 | 6/9 | no plate wear up to |
| | Preparation Example 3 | o-Cl-Habi³⁾ | | | 50,000 copies |
| 4 | 0.5 g | 0.17 g | 7/10 | 6/9 | no plate wear up to |
| | Preparation Example 4 | o-Cl-Habi³⁾ | | | 50,000 copies |
| Comparative 1 | — | 0.17 g | 2/5 | 3/6 | plate wear after 10,000 copies |
| | | o-Cl-Habi³⁾ | | | |
| Comparative 2 | 0.5 g | — | no image | no image obtained | not determined |
| | Preparation Example 1 | | obtained | | |
| Comparative 3 | 0.5 g | 0.26 g | no image | no image obtained | not determined |
| (as in DD 287 796) | Preparation Example 1 | iodonium salt⁴⁾ | obtained | | |
| Comparative 4 | 0.5 g | 0.26 g | 1/5 | 1/5 | plate wear after 10,000 copies |
| | Preparation Example 1 | triazine⁵⁾ | | | |
| Comparative 5 | 0.5 g | 0.4 g | 1/4 | 1/4 | plate wear after 10,000 copies |
| | Preparation Example 1 | methoxypyridinium salt⁸⁾ | | | |
| Comparative 6 | 0.5 g | 0.4 g | no image | no image obtained | not determined |
| | Preparation Example 1 | tribromomethylphenyl- | obtained | | |
| | | sulfone | | | |

¹⁾The first value indicates the solid steps of the blackened gray scale and the second value indicates the first step that did not accept printing ink.
²⁾Storage stability test: Result obtained after 60 minute storage of the unexposed plate precursor at 90° C.
³⁾2,2-Bis-(2-chlorophenyl)-4,5,4′,5′-tetraphenyl-2′H-[1,2′]biimidazolyl
⁴⁾Diphenyliodonium chloride
⁵⁾2-(4-Methoxyphenyl)-4,6-bis-(trichloromethyl)-1,3,5-triazine
⁶⁾4-Phenyl-1-methoxypyridinium-tetrafluoroborate

### Example 5 and Comparative Example 7

### Exposure with a 405 nm Laser Diode

The same coating composition as used in Example 4 was used in Example 5. The same coating composition as used in Comparative Example 1 was used in Comparative Example 7. Both plates were exposed with an energy of 300 μJ/cm² by means of a laser diode emitting at 405 nm using the UGRA gray scale. The plates were then developed as described in Examples 1 to 4 and Comparative Examples 1 to 6.

The following results were obtained:
Example 5: gray scale 3/7; gray scale 3/7 for the plate after storage for 60 minutes at 90° C.
Comparative Example 7: no image was obtained

The examples according to the present invention confirm the synergistic effect of the combination of 1,4-dihydropyridines and hexaarylbiimidazoles during the initiation of free-radical polymerization; the compositions of the present invention are characterized by a very high photospeed.

1. A radiation-sensitive composition comprising
(a) one or more types of monomers and/or oligomers and/or polymers, each comprising at least one ethylenically unsaturated group accessible to a free-radical polymerization,
(b) at least one sensitizer,
(c) at least one coinitiator capable of forming free radicals together with the sensitizer (b) and selected from hexaarylbiimidazoles; and (d) optionally one or more components selected from alkali-soluble binders, dyes, exposure indicators, plasticizers, chain transfer agents, leuco dyes, surfactants, inorganic fillers and thermopolymerization inhibitors,
characterized in that the at least one sensitizer is a 1 ,4-dihydropyridine derivative of the formula (I) 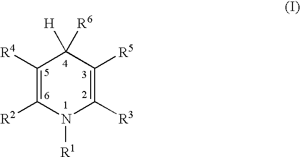
wherein
R^{l} is selected from a hydrogen atom, —C(O)OR⁷, an optionally substituted alkyl group, an optionally substituted aryl group and an optionally substituted aralkyl group,
R² and R³ are independently selected from optionally substituted alkyl groups, optionally substituted aryl groups, CN and a hydrogen atom, R⁴ and R⁵ are independently selected from —C(O)OR⁷, —C(O)R⁷, —C(O)NR⁸R⁹ and CN, or R² and R⁴ together form an optionally substituted phenyl ring or a 5- to 7-membered carbocyclic or heterocyclic ring, wherein the unit 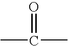
is present in the carbocyclic or heterocyclic ring adjacent to position 5 of the 1,4-dihydropyridine ring and wherein the carbocyclic or heterocyclic ring optionally comprises additional substituents,
or both R² and R⁴ as well as R³ and R⁵ form either optionally substituted phenyl rings or 5- to 7-membered carbocyclic or heterocyclic rings, wherein the unit 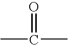
is present in the carbocyclic or heterocyclic rings adjacent to positions 3 and 5 of the dihydropyridine ring and wherein the carbocyclic or heterocyclic rings optionally comprise additional substituents,
or one of the pairs R²/R⁴ and R³/R⁵ forms a 5- to 7-membered carbocyclic or heterocyclic ring, wherein the unit 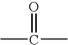
is present in the carbocyclic or heterocyclic ring adjacent to position 5 or 3 of the dihydropyridine ring and wherein the carbocyclic or heterocyclic ring optionally comprises additional substituents and the other pair forms an optionally substituted phenyl ring,
or R² and R¹ or R³ and R¹ form a 5- to 7-membered heterocyclic ring which can optionally comprise one or more substituents and which, in addition to the nitrogen atom it shares with the 1,4-dihydropyridine ring, optionally comprises additional nitrogen atoms, —NR¹³ groups, —S— or —O—,
R¹³ is selected from a hydrogen atom, an alkyl group, aryl group and aralkyl group,
R⁶ is selected from an alkyl group optionally substituted with a halogen atom or a —C(O) group, an optionally substituted aryl group, an optionally substituted aralkyl group, an optionally substituted heterocyclic group and the group 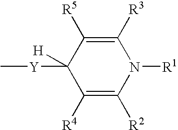
Y is an alkylene group or an arylene group,
R⁷ is a hydrogen atom, aryl group, aralkyl group or alkyl group, wberein the alkyl group and the alkyl unit of the aralkyl group optionally comprise one or more C—C double and/or C—C triple bonds,
and R⁸ and R⁹ are independently selected from a hydrogen atom, an optionally substituted alkyl group, an optionally substituted aryl group and an optionally substituted aralkyl group,
provided that the 1,4-dihydropyridine derivative of formula (I) does not contain any nitro groups bonded to an aromatic ring.

2. The radiation-sensitive composition of claim 1, R² and R³ are independently selected from optionally substituted alkyl groups, optionally substituted aryl groups, CN and a hydrogen atom, and R⁴ and R⁵ are independently selected from —C(O)OR⁷, —C(O)R⁷, —C(O)NR⁸R⁹ and CN, wherein R⁷, R⁸ and R⁹ are as defined in claim 1.

3. The radiation-sensitive composition of claim 1, wherein the sensitizer is a 1,4-dihydropyridine of formula (Ia): 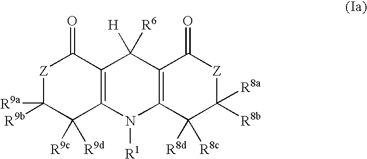
wherein R¹ and R⁶ are as defined in claim 1,
the groups R^{8a} to R^{8d} and R^{9a} to R⁹ are independently selected from a hydrogen atom, alkyl groups and aryl groups, wherein two groups R⁹and/or two groups R⁸ of adjacent ring carbon atoms can also form a saturated or unsaturated carbocyclic or heterocyclic ring or fused aromatic ring together,
each Z is independently selected from CR¹³₂, O, S and NR¹³ and
each R¹³ independently represents a hydrogen atom, alkyl, aralkyl or aryl group,
formula (Ib): 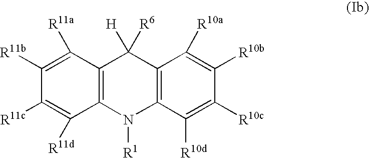
wherein R¹ and R⁶ are as defined above,
R^{10a} to R^{10d} to R^{11a} to R^{11d} are independently selected from a hydrogen atom, alkyl groups, aryl groups, aralkyl groups, halogen atoms, CN, NR¹³₂, C(O)OR¹³ and OR¹³, wherein two groups R¹¹ and/or two groups R¹⁰ of adjacent ring carbon atoms can also form an unsaturated carbocyclic or heterocyclic ring or fused aromatic ring together, and
each R¹³ independently represents a hydrogen atom, alkyl, aralkyl or aryl group,
formula (Ic): 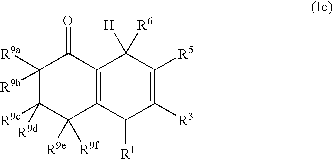
wherein R¹, R³, R⁵ and R⁶ are as defined above and the groups R^{9a} to R^{9f} are independently selected from a hydrogen atom, alkyl groups, aryl groups, aralkyl groups, halogen atoms, CN, NR¹³₂, C(O)OR¹³ and OR¹³, wherein two groups R⁹ of adjacent ring carbon atoms can also form a saturated or unsaturated carbocyclic or heterocyclic ring or fused aromatic ring together, and
R¹³ independently represents a hydrogen atom, alkyl, aralkyl or aryl group,
formula (Id): 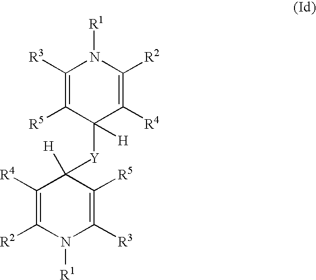
wherein each R¹, R², R³, R⁴ and R⁵ independently is as defined in claim 1 and
Y is selected from alkylene and arylene,
formula (Ie): 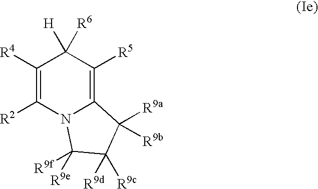
wherein R², R⁴, R⁵ and R⁶ are as defined above and groups R^{9a} to R^{9f} are defined as are groups R^{9a} to R^{9d} of formula (Ia) above,
formula (If): 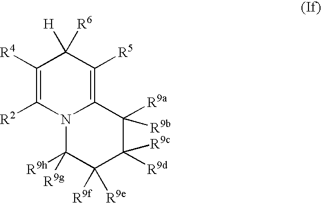
wherein R² R⁴, R⁵ and R⁶ are as defined above and groups R^{9a} to R^{9h} are defined as are groups R^{9a} to R^{9d} of formula (Ia) above or
fornula (Ig): 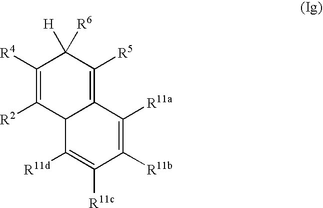
wherein R², R⁴, R⁵ and R⁶ are as defined above and the groups R^{11a} to R^{11d} are independently selected from a hydrogen atom, alkyl groups, aryl groups, aralkyl groups, halogen atoms, CN, NR¹³₂, C(O)OR¹³ and OR¹³, wherein two adjacent groups R¹¹ can also form an unsaturated carbocyclic or heterocyclic ring or fused aromatic ring together and R¹³ independently represents a hydrogen atom, alkyl, aralkyl or aryl group.

4. The radiation-sensitive composition of claim wherein the coinitiator (c) is selected from 2,2-bis-(2-chlorophenyl-4,5,4′,5′-tetraphenyl-2′H [1,2′]biimidazole and 2,2′-bis-(2-chlorophenyl)-4,4′,5,5′-tetra(m-methoxy-phenyl)-biimidazole.

5. The radiation-sensitive composition of claim 1 further comprising one or more chain transfer agents.

6. A negative working radiation-sensitive element comprising
(a) an optionally pretreated substrate and
(b) a radiation-sensitive coating of the radiation-sensitive composition of claim 1 that has been applied onto the substrate.

7. (canceled)

7. The negative working radiation-sensitive element of claim 6, wherein the substrate is an aluminum plate or foil that has been subjected to at least one treatment selected from graining, anodizing and hydrophilizing.

8. The negative working radiation-sensitive element of claim 6 further comprising an oxygen-impermeable overcoat.

9. The negative working radiation-sensitive element of claim 6 wherein the sensitizer is a 1,4-dihydropyridine of formula (Ia): 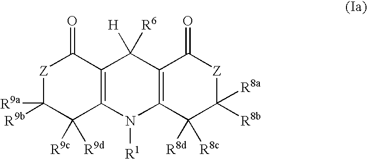
wherein R¹ and R⁶ are as defined in claim 1,
the groups R^{8a} to R^{8d} and R^{9a} to R^{9d} are independently selected from a hydrogen atom, alkyl groups, and aryl groups wherein two groups R⁹ and/or two groups R⁸ of adjacent ring carbon atoms can also form a saturated or unsaturated carbocyclic or heterocyclic ring or fused aromatic ring together,
each Z is independently selected from CR¹³₂, O, S and NR¹³ and
each R¹³ independently represents a hydrogen atom, alkyld aralkyl or aryl group,
formula (Ib): 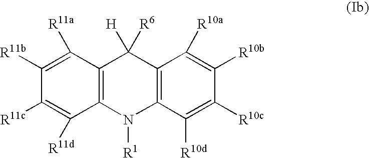
wherein R¹ and R⁶ are as defined above,
R^{10a} to R^{10d} and R^{11d} are independently selected from a hydrogen atom, alkyl groups, aryl groups, aralkyl groups, halogen atoms, CN, NR¹³₂ , C(O)OR¹³ and OR¹³, wherein two groups R¹¹ and/or two groups R¹⁰ of adjacent ring carbon atoms can also form an unsaturated carbocyclic or heterocyclic ring or fused aromatic ring together, and
each R¹³ independently represents a hydrogen atom, alkyl, aralkyl or aryl group.
formula (Ic): 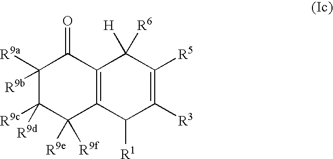
wherein R¹, R³, R⁵ and R⁶ are as defined above and the groups R^{9a} to R^{9f} are independently selected from a hydrogen atom. alkyl groups, aryl groups. aralkyl groups, halogen atoms, CN, NR¹³₂, C(O)OR¹³ and OR¹³, wherein two groups R⁹ of adjacent ring carbon atoms can also form a saturated or unsaturated carbocyclic or heterocyclic ring or fused aromatic ring together, and
R¹³ independently represents a hydrogen atom, alkyl, aralkyl or aryl group,
formula (Id): 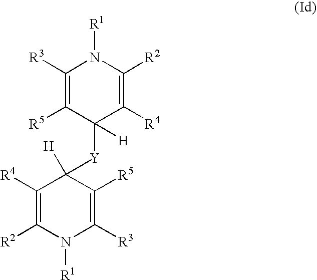
wherein each R¹, R² , R³, R⁴ and R⁵ independently is as defined in claim 1 and
Y is selected from alkylene and arylene.
formula (Ie): 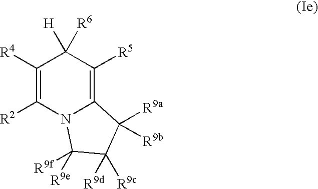
wherein R², R⁴, R⁵ and R⁶ are as defined above and groups R^{9a} to R^{9f} are defined as are groups R^{9a} to R^{9d} ; of formula (Ia) above,
formula (If): 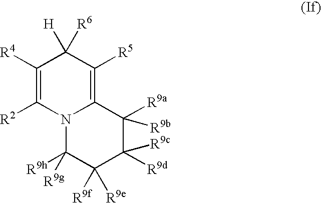
wherein R², R⁴, R⁵ and R⁶ are as defined above and groups R^{9a} to R^{9h} are defined as are groups R^{9a} to R^{9d} of formula (Ia) above, or
formula (Ig): 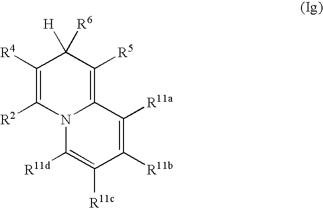
wherein R^{2,} R⁴, R⁵ and R⁶ are as defined above and the groups R^{11a} to R^{11d} are independently selected from a hydrogen atom, alkyl groups, aryl groups, aralkyl groups, halogen atoms, CN, NR¹³₂, C(O)OR¹³ and OR¹³, wherein two adjacent groups R¹¹ can also form an unsaturated carbocyclic or heterocyclic ring or fused aromatic ring together and R¹³ independently represents a hydrogen atom, alkyl, aralkyl or aryl group.

10. A process for imaging a radiation-sensitive element comprising
(a) providing the negative working radiation-sensitive element of claim 6;
(b) image-wise exposures of the element to UV radiation;
(c) optionally heating the image-wise irradiated element;
(d) removing the non-exposed areas by means of an aqueous alkaline developer; and
(e) optionally heating the developed element and/or subjecting it to overall exposure.

11. The process of claim 10, wherein the image-wise exposure is carried out with UV radiation of a wavelength in the range of 250 to 450 nm.

12. An imaged element obtained from the process of claim 10.

13. The imaged element of claim 12, that is a lithographic printing form.

14. A process for producing a radiation-sensitive element comprising
(a) providing an optionally pretreated substrate,
(b) providing a radiation-sensitive composition comprising
(i) one or more types of monomers and/or oligomers and/or polymers, each comprising at least one ethylenically unsaturated group accessible to a free-radical polymerization,
(ii) at least one sensitizer,
(iii) at least one coinitiator capable of forming free radicals together with the sensitizer (b) and selected from hexaarylbiimidazoles;
(iv) optionally one or more components selected from alkali-soluble binders, dyes, exposure indicators, plasticizers, chain transfer agents, leuco dyes, surfactants, inorganic fillers and thermopolymerization inhibitors, and
(v) at least one solvent,
characterized in that the sensitizer is a 1,4-dihydropyridine derivative of formula (I) 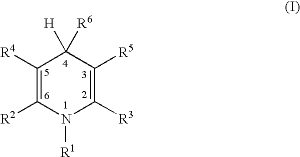
wherein
R¹is selected from a hydrogen atom, —C(O)OR⁷, an optionally substituted alkyl group, an optionally substituted aryl group and an optionally substituted aralkyl group,
R² and R³ are independently selected from optionally substituted alkyl groups, optionally substituted aryl groups, CN and a hydrogen atom, R⁴ and R⁵ are independently selected from —C(O)OR⁷, —C(O)R⁷, —C(O)NR⁸R⁹ and CN,
or R² and R⁴ together form an optionally substituted phenyl ring or a 5- to 7-membered carbocyclic or heterocyclic ring, wherein the unit 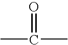
is present in the carbocyclic or heterocyclic ring adjacent to position 5 of the dihydropyridine ring and wherein the carbocyclic or heterocyclic ring optionally comprises additional substituents,
or both R² and R⁴ as well as R³ and R⁵ form either optionally substituted phenyl rings or 5- to 7-membered carbocyclic or heterocyclic rings, wherein the unit 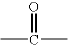
is present in the carbocyclic or heterocyclic rings adjacent to positions 3 and 5 of the dihydropyridine ring and wherein the carbocyclic or heterocyclic rings optionally comprise additional substituents,
or one of the pairs R²/R⁴ and R³/R⁵ forms a 5- to 7-membered carbocyclic or heterocyclic ring, wherein the unit 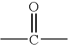
is present in the carbocyclic or heterocyclic ring adjacent to position 5 or 3 of the dihydropyridine ring and wherein the carbocyclic or heterocyclic ring optionally comprises additional substituents and the other pair forms an optionally substituted phenyl ring,
or R² and R¹ or R³ and R¹ form a 5- to 7-membered heterocyclic ring which can optionally comprise one or more substituents and which, in addition to the nitrogen atom it shares with the 1,4-dihydropyridine ring, optionally comprises additional nitrogen atoms, —NR¹³ groups, 13 S—or —O—, R¹³ is selected from a hydrogen atom, an alkyl group, aryl group and aralkyl group,
R⁶ is selected from an alkyl group optionally substituted with a halogen atom or a —C(O) group, an optionally substituted aryl group, an optionally substituted aralkyl group, an optionally substituted heterocyclic group and the group 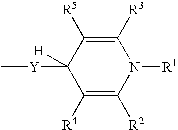
Y is an alkylene group or an arylene group, R⁷ is a hydrogen atom, aryl group, aralkyl group or alkyl group, wherein the alkyl group and the alkyl unit of the aralkyl group optionally comprise one or more C—C double and/or C—C triple bonds,
and R⁸ and R⁹ are independently selected from a hydrogen atom, an optionally substituted alkyl group, an optionally substituted aryl group and an optionally substituted aralkyl group, provided that the 1,4-dihydropyridine derivative of formula (I) does not contain any nitro groups bonded to an aromatic ring.

15. The process of claim 14, wherein the substrate is an aluminum substrate that has been subjected to at least one treatment selected from graining, anodizing and hydrophilizing.

16. (canceled)
